(19) United States
(12) Patent Application Publication
(10) Pub. No.: US 2014/0164534 A1
(43) Pub. Date: Jun. 12, 2014

(54) SYSTEM FOR SENDING A CONTENT ITEM THROUGH AN ONLINE CONTENT MANAGEMENT SYSTEM

(71) Applicant: DROPBOX, INC., San Francisco, CA (US)

(72) Inventors: Ilya Fushman, Palo Alto, CA (US); Sean Lynch, San Francisco, CA (US)

(73) Assignee: DROPBOX, INC., San Francisco, CA (US)

(21) Appl. No.: 13/777,184

(22) Filed: Feb. 26, 2013

Related U.S. Application Data
(60) Provisional application No. 61/735,536, filed on Dec. 10, 2012.

(51) Int. Cl. H04L 12/24

(52) U.S. Cl. CPC H04L 41/026
USPC 709/206

(57) ABSTRACT

The disclosed embodiments provide a system that facilitates sending a content item to a recipient through an online content management system. During operation, the system receives a command to send a message including the content item to the recipient, wherein the command may or may not specify that the content item is to be sent through the online content management system. In response to the command, the system sends the content item through the online content management system to the recipient. During this sending process, the system uploads the content item to the online content management system, wherein the uploading process returns a link to the uploaded content item. Next, the system sends the message including the link to the recipient, which enables the recipient (or a client that is acting on behalf of the recipient) to access the content item from the online content management system.

### RELATED APPLICATION

This claims priority under 35 U.S.C. §119 to U.S. Provisional Application No. 61/735,536, entitled “Email System Integrated with a Cloud-Based Content Management System,” filed 10 Dec. 2012.

### BACKGROUND

1. Field

The disclosed embodiments generally relate to online content management systems. More specifically, the disclosed embodiments relate to a system that facilitates sending a content item to a recipient through an online content management system.

2. Related Art

Users often send content items, such as files or photographs, to other users. For example, users often include a content item as an attachment with an email message or a text message. Users are also beginning to send content items to other users through instant-messaging sessions. However, in some cases, the content item can be large, which can cause the associated message to take a long time to be transmitted to the recipient. Moreover, if the attachment size exceeds an attachment quota for a messaging system, a text-messaging system or an instant-messaging system (for example, if the attachment is larger than 25 megabytes), the message cannot be transmitted to the recipient.

Also, users sometimes retrieve content items they are interested in attaching from a synched, online content management system, such as the Dropbox™ service, which is offered by Dropbox, Inc. of San Francisco, Calif. In existing systems, if a content item from an online content management system needs to be attached to a message, the content item must first be copied to the user's computing device before the content item is attached to the message. This additional copying step introduces delay. Moreover, if the user is sending a message from a shared computing device or a friend's computing device, it may be undesirable to store a copy of the content item to the computing device. Also, storing a copy of a content item on a user's mobile computing device consumes valuable storage space.

### SUMMARY

The disclosed embodiments provide a system that facilitates sending a content item to a recipient through an online content management system. During operation, the system receives a command to send the content item to the recipient, wherein the command may or may not specify that the content item is to be sent through the online content management system. In response to the command, the system sends the content item through the online content management system to the recipient. During this sending process, the system uploads the content item to the online content management system, wherein the uploading process returns a link to the uploaded content item. Next, the system sends the link to the recipient, which enables the recipient (or a client that is acting on behalf of the recipient) to access the content item from the online content management system. In some embodiments, the content item is sent through the online content management system if a size of the content item exceeds a threshold. Otherwise, the content item is sent directly to the recipient without sending the content item through the online content management system.

### BRIEF DESCRIPTION OF THE FIGURES

FIG. 1 shows a content management environment in accordance with the disclosed embodiments.

FIG. 2A presents a flow chart illustrating the process of sending a content item through an online content management system in accordance with the disclosed embodiments.

FIG. 2B presents a flow chart illustrating the process of handling a large message attachment in accordance with the disclosed embodiments.

FIG. 3 presents a flow chart illustrating the process of attaching a file from an online content management system to a message in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

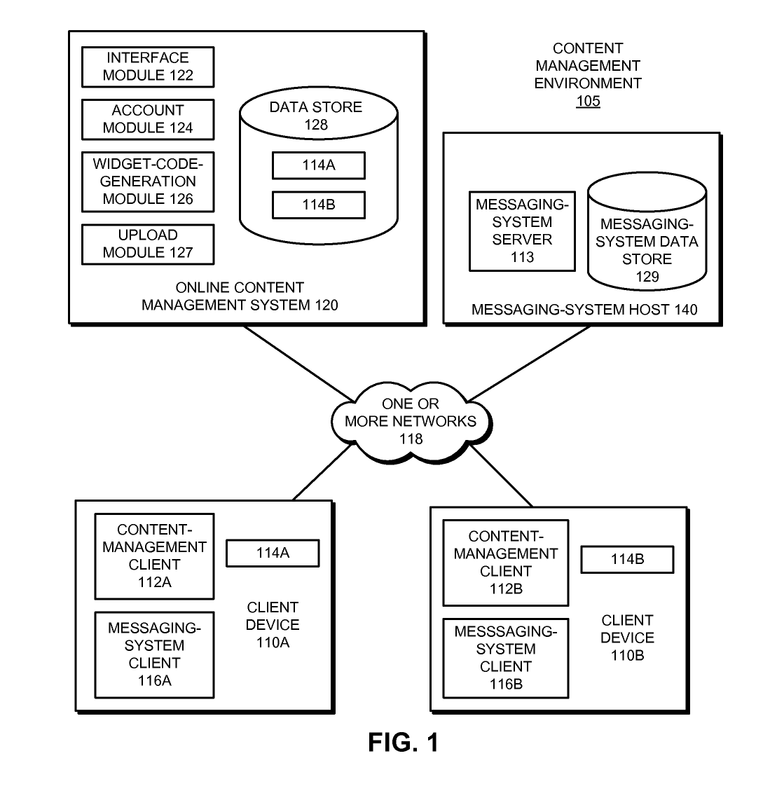

FIG. 1 shows content management environment 105 according to various embodiments. Although the exemplary embodiment of content management environment 105 shown FIG. 1 includes a messaging-system server 113 and associated messaging-system clients 116A-116B for sending content items as message attachments, other embodiments are not limited to email systems and may for example send content items as attachments to text messages through a texting system, or more generally through any type of system that facilitates communicating electronic messages between users. As may be understood from FIG. 1, content management environment 105 includes a plurality of client devices 110A and 110B (collectively 110), a messaging-system server 113 (which resides on a messaging-system server host 140 and is associated with a messaging-system data store 129) and an online content management system 120, which are all interconnected by one or more networks 118.

For purposes of illustration, the embodiments that appear in FIG. 1 show a messaging system comprising a messaging-system server 113 and messaging-system clients 116A-116B. Note that the described system can generally include any messaging system that can be used to communicate content items between users. For example, the described system can include an email system (or a text-messaging system) that can send content items as attachments. The described system can also include to an instant-messaging system (chat system) that can send content items between participants in an instant-messaging session. In another example, the messaging system can be a general non-SMS-based messaging service, such as iMessage™ system developed by Apple Inc. of Cupertino, Calif. iMessage™ was developed as an alternative to SMS/MMS messaging protocols and allows users to send texts, documents, photos and other content items over WiFi, 3G or LTE networks to other users. iMessage™ also facilitates “group chat” sessions between more than two users.

Various aspects of the client devices 110, messaging-system server 113 and content management system 120 are discussed below.

### Client Devices

In various embodiments, each client device 110 may selectively execute a content-management system client application 112A and 112B (collectively 112) (also referred to as a “content-management client”), which may be used to manage content items (such as files, folders or other data items) stored within a content management system 120. It is noted that, in some embodiments, synchronized copies of content items 114A and 114B may be kept on both content management system 120 and each respective client device 110. In some embodiments, client devices 110 may provide a file-browser type interface (not shown) for directly manipulating the content items stored on content management system 120 without maintaining a local copy. Client devices 110 may also include messaging-system clients 116A and 116B (collectively 116) for receiving and sending messages associated with messaging-system server 113. Note that these messaging-system clients 116A and 116B can be web-based or native-client-based messaging-system clients.

While only two client devices 110A and 110B are shown in FIG. 1 for purposes of clarity, it should be understood by those skilled in the relevant field that many client devices 110A and 110B may simultaneously connect through network(s) 118 to messaging-system server 113 and content management system 120 at any given time. Examples of suitable client devices 110 include, but are not limited to, a desktop computer; mobile computing devices, such as a laptop or a tablet; and handheld devices, such as a smartphone (e.g., an IPHONE®, BLACKBERRY®, or ANDROID™-based smartphone). Each client device 110 may store a local, synched copy of one or more content items from within content management system 120, and the content items may be stored in any suitable format. When content-management client 112 presents content items that are stored within the file storage system to a user, the content items may be arranged in folders and the folders themselves may be arranged in other folders, or in any other arbitrary arrangement supported by content management system 120, as determined by the user. However, one of skill in the art should understand in light of this disclosure that each user's file storage architecture may be considerably different from the next, and in some instances, the file storage architecture may be implemented to maximize storage and file retrieval efficiency.

### Content Management System

Content management system 120 stores content items and manages access to those content items via client devices 110. Content management system 120 and its components may be implemented using any appropriate hardware and software for content item serving, storage, and retrieval functions. For example, content management system 120 may be implemented in the form of a single server or multiple servers.

In various embodiments, content management system 120 includes interface module 122, account module 124, widget-code-generation module 126, upload module 127, and data store 128. Some of these elements of content management system 120 are discussed below.

### Content Management System—Interface Module

In particular embodiments, interface module 122 may facilitate content item access and content item storage between content management system 120 and client devices 110. Interface module 122 may receive content items from and send content items to client devices 110 consistent with the user's preferences for sharing content items. Interface module 122 may act as the counterpart to a client-side file-explorer style user interface that allows a user to manipulate content items directly stored on content management system 120. In some embodiments, software operating on client devices 110 may integrate network-stored content items with the client's local file system to enable a user to manipulate network-stored content items through the same user interface (UI) used to manipulate content items on the local file system, e.g., via a file explorer, file finder or browser application. As an alternative or supplement to the client-side file-explorer interface, interface module 122 may provide a web interface for client devices 110 to access (e.g., via a suitable messaging-system client 116) and allow a user to manipulate content items stored within content management system 120. In this way, the user can directly manipulate content items stored within content management system 120.

### Content Management System—Data Store

In various embodiments, data store 128 may store content items such as those uploaded using client devices 110, or using any other suitable computing device. In the embodiment illustrated in FIG. 1, client device 110A, which is associated with a first user, is shown as locally storing at least one content item 114A, and client device 110B, which is associated with a second user, is shown as locally storing at least one content item 114B. As shown in FIG. 1, copies of the locally stored content items are maintained in data store 128 of content management system 120.

In various embodiments, data store 128 may maintain information identifying the user, information describing the user's file directory, and other information in a file journal that is maintained for each user. In some embodiments, the file journal may be maintained on content management system 120, and in other embodiments, a file journal (e.g., a “server-side file journal”) may be maintained on both content management system 120 and locally on each client device 110. In various embodiments, the file journal may be used to facilitate the synchronization of the various copies of a particular content item that are associated with a user's account.

As a particular example, in the embodiment shown in FIG. 1, the system may be configured so that any changes that are made to content item 114A on particular client device 110A may also be automatically reflected in the copy of content item 114A stored within content management system 120. Similarly, any changes that are made to content item 114A on content management system 120 may also be automatically reflected in the copy of content item 114A stored on client device 110A.

### Content Management System—Account Module

In particular embodiments, account module 124 may track content items stored in data store 128 and entries in the server-side file journal for each content item. As users grant file access permissions to other users, account module 124 may update the server-side file journal associated with each relevant user in data store 128. Account module 124 may also track client devices 110 that are associated with each user's account. For example, a user may want to share all their content items between their desktop computer, tablet computer, and mobile device. To make such a sharing arrangement seamless to the user, the user's single account on content management system 120 may be associated with each of the user's respective client devices. In some embodiments, an application running on each respective client device 110 may help to coordinate synchronization of content items on the client device with corresponding versions of the content items within the user's account in content management system 120, and also with corresponding versions of the content items stored on the user's various other client devices.

### Content Management System—Widget-Code-Generation Module

In particular embodiments, widget-code-generation module 126 may be configured to generate code that may be used to create a message-attachment widget on a remote messaging-system client. In particular embodiments, this code may be HTML code that may be pasted into a messaging-system client to create the message-attachment widget. In other embodiments, the code may be program code which is integrated into a native-client-based messaging system. In particular embodiments, the message-attachment widget may include: (1) a button that may be used to select one or more attachments from a user's messaging-system client; and (2) code to facilitate the upload of the selected attachments directly from the messaging-system client to content management system 120. Also, in particular embodiments, the message-attachment widget may include: (1) a button that may be used to activate a file-selection interface to select a content item to be attached to a message; and (2) code to facilitate including a link to the selected content item in the message.

Sending a Content Item through an Online Content-Management System

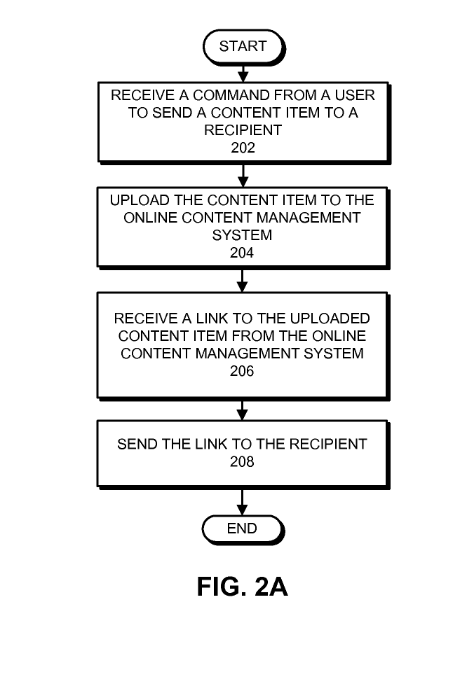

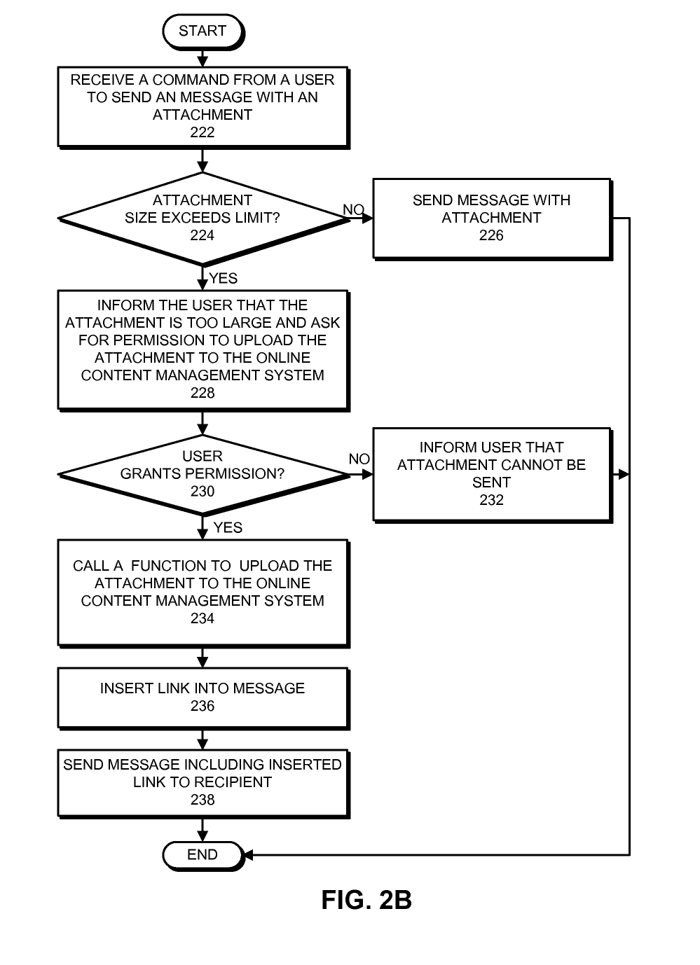

FIG. 2A presents a flow chart illustrating the general process of sending a content item through an online content management system in accordance with the disclosed embodiments. First, the system receives a command from the user to send a content item to a recipient (step 202). Note that this content item can generally include any type of electronic content, including a data file, a photo, an audio clip, or a video. Moreover, the command can comprise a command to send an email message, a text message or an instant message that includes the content item as an attachment. In some embodiments, the user explicitly requests the content item be sent though the online content management system. In this case, the received command explicitly specifies that the content item is to be sent through the online content management system. In other embodiments, the user does not request that the content item be sent through the online content management system. In this case, the received command does not specify the content item be sent through the online content management system, and the system automatically sends the content item through the online content management system, for example if the size of the content item exceeds a threshold.

In response to this command, the system uploads the content item to the online content management system (step 204). During the uploading process, the system receives a link to the uploaded content item from the online content management system (step 206). Finally, the system sends the link to the recipient (step 208). This link enables the recipient (or a client that is acting on behalf of the recipient) to access the content item from the online content management system.

We next describe two specific embodiments that operate within a messaging system.

### Handling a Large Message Attachment

FIG. 2B presents a flow chart illustrating the process of handling a large message attachment in accordance with the disclosed embodiments. This process generally operates as follows. First, the system receives a command from the user to send a message with an attachment to one or more recipients (step 222). In response to this command, the system determines whether the attachment (or if there are multiple attachments, the aggregate size of the attachments) exceeds a size limit for the messaging system (step 224). For example, the limit can be an attachment quota of the messaging system, which may be 25 megabytes. If the attachment does not exceed the size limit, the system sends the message with the attachment to the one or more recipients and the process is complete (step 226).

On the other hand, if the attachment size exceeds the limit, the system informs the user that the attachment is too large and asks the user for permission to upload the attachment to the online content management system (step 228). The system then waits for the user to respond (step 230). If the user does not respond or does not grant permission, the system informs the user that the attachment(s) cannot be sent with the message (step 232).

On the other hand, if the user grants permission to upload the attachment, the system calls a function to upload the attachment to the online content management system, wherein the attachment can be uploaded into a location associated with the user within the online content management system (step 234). Note that this function can be provided to the developers of the messaging system by an entity that operates the online content management system. When the upload is complete, the online content management system returns a link to the attachment to the messaging system.

Finally, the messaging system inserts a link to the uploaded attachment into the message (step 236), and sends the message including the inserted link to the one or more recipients (step 238).

### Attaching a Content Item From an Online Content Management System

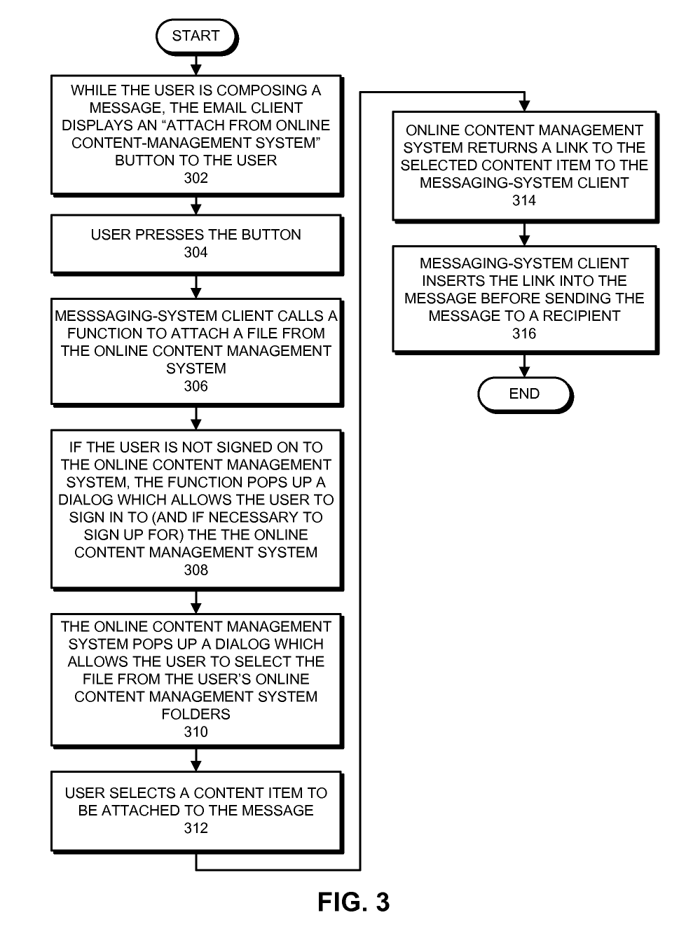

FIG. 3 presents a flow chart illustrating the process of attaching a content item from an online content management system to a message in accordance with the disclosed embodiments. In some embodiments, an organization that runs the online content management system provides a library to programmers of the messaging-system client. This library includes functions that allow users of a messaging-system client to include message attachments from the online content management system. For example, the programmers of the messaging-system client can create a button in a user interface (UI) for the messaging-system client that says “include attachment from online content-management system,” wherein pressing the button triggers a library function that allows the user to select an attachment from the online content management system. This function generally operates as follows.

First, while a user is composing a message, the messaging-system client provides an “Attach From Online Content-Management System” button to the user (step 302). Next, the user presses the button (step 304). In response, the messaging-system client calls a function provided by the online content management system to attach a content item from the online content management system (step 306).

Then, if the user is not signed on to the online content management system, the function pops up a dialog box that enables the user to sign on to (and if necessary to sign up with) the online content management system (step 308).

Next, the online content management system pops up a dialog box that provides a selection interface that allows the user to navigate through and select a content item from the user's folders in the online content management system to attach to the message (step 310). In some embodiments, the selection interface allows the user to access a website that is hosted in the online content management system. This website provides a file system view into the user's account on the online content management system and allows the user to navigate through a hierarchical directory structure to select a content item. After the user selects a content item (step 312), the online content management system returns a link to the selected content item to the messaging-system client (step 314). Finally, the messaging-system client inserts the link into the message before sending the message to one or more recipients (step 316).

### Variations

The above-described system can operate within a number of different types of messaging services, such as an email service, a text-messaging service or an instant-messaging service. Moreover, within each of these types of messaging services the uploading of a content item to the online content management system can be triggered in different ways. In one scenario, the user can explicitly ask the system to upload the attachment to the online content management system. For example, an instant-messaging client can provide a user interface element that allows the user to enter commands to send a content item to one or more participants in an instant-messaging session. In this example, the content item can be sent as an attachment to an instant message, or alternatively the content item can be sent separately from an instant message. If the content item is sent separately from an instant message, the instant-messaging system can include a separate user interface element (e.g., frame) to transfer the content item, wherein this user interface element is separate from user interface elements associated with message creation. In an email system or a text-messaging system, the command to attach a content item to a message can include an option to upload the content item to the online content management system. In some cases, the command to upload the content item to the online content management system can be overridden if for example the online content management system becomes overly busy or lacks storage capacity.

Alternatively, the uploading process can be automatically initiated based on one or more factors, including: the size of the attachment, available bandwidth between the messaging-system client and the online content management system, available bandwidth between the online content management system and the attachment recipient, and available storage capacity within the online content management system.

Also, the triggering of the uploading can also take place at different times. For example, in an email system the uploading process can be triggered when the content item is attached to the email, whereas in a text-messaging system the uploading process can be triggered when the associated text message is sent to the recipient.

Also, different types of links can be used to access the content item from the online content management system. In general, the system needs to communicate some type of identifier to facilitate retrieving the content item from the online content management system. For example, the identifier can be a name (such as a filename) that can be used to identify the message attachment, or simply a numerical index that can be used to reference the message attachment. Alternatively, the identifier can specify a location for the message attachment, such as a URL, a file system pointer or a memory address.

The content item can also be stored in a number of possible locations in the online content management system. For example, the content item can uploaded to a storage area associated with the message sender, such as a temporary directory under the message sender's account. Alternatively, the content item can be uploaded to a storage area associated with the message recipient's account in the online content management system. In another embodiment, the content item can be uploaded to a storage area associated with the messaging system. For example, an email system can reserve space in the online content management system to store content items which are being communicated as email attachments.

At the receiving end, the content item can be presented as a link that the message recipient can activate to download the content item. Alternatively, the content item can be automatically downloaded from the online content management system to a temporary storage area after the message is received. This automatic downloading process can take place in the background, for example before the recipient accesses the received message. The message recipient can subsequently move the content item from the temporary storage area to a desired destination.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A computer-implemented method for enabling a user to send a content item through an online content management system, the method comprising:
receiving a command to send a message which includes the content item to one or more recipients; and
in response to the command, sending the content item through the online content management system to the one or more recipients by,
uploading the content item to the online content management system,
receiving a link to the uploaded content item from the online content management system, and
sending the message including the link to the one or more recipients.

2. The computer-implemented method of claim 1, wherein the command specifies that the content item is to be sent through the online content management system.

3. The computer-implemented method of claim 1, wherein in response to the command, the content item is sent to the one or more recipients through the online content management system if a size of the content item exceeds a threshold, and otherwise the content item is sent directly with the message to the one or more recipients.

4. The computer-implemented method of claim 1, wherein the message comprises one of, an email message, a text message and an instant message.

5. The computer-implemented method of claim 1, wherein prior to uploading the content item, the method further comprises:
requesting permission to upload the content item to the online content management system;
upon receiving a response granting permission to upload the content item, proceeding to upload the content item; and
if no response granting permission to upload the content item is received, informing the user that the content item cannot be sent.

6. The computer-implemented method of claim 1, wherein uploading the content item to the online content management system includes calling functionality in a code module to perform the uploading, wherein the code module is provided by an entity that operates the online content management system.

7. A computer-implemented method for enabling a user to send a content item through an online content management system, comprising:
receiving a call to upload the content item at the online content management system, the call having been generated by a client upon receiving a request to send a message which includes the content item to one or more recipients; and
in response to the call,
uploading the content item to the online content management system, and
returning a link to the uploaded content item to the client so the client can send the message including the link to the one or more recipients.

8. The computer-implemented method of claim 7, wherein the message comprises one of, an email message, a text message and an instant message.

9. A non-transitory computer-readable storage medium storing instructions that when executed by a computer cause the computer to perform a method for enabling a user to send a content item through an online content management system, the method comprising:
receiving a command to send a message which includes the content item to one or more recipients; and
in response to the command, sending the content item through the online content management system to the one or more recipients by,
uploading the content item to the online content management system,
receiving a link to the uploaded content item from the online content management system, and
sending message including the link to the one or more recipients.

10. The non-transitory computer-readable storage medium of claim 9, wherein the command specifies that the content item is to be sent through the online content management system.

11. The non-transitory computer-readable storage medium of claim 9, wherein in response to the command, the content item is sent to the one or more recipients through the online content management system if a size of the content item exceeds a threshold, and otherwise the content item is sent directly with the message to the one or more recipients.

12. The non-transitory computer-readable storage medium of claim 9, wherein the message comprises one of, an email message, a text message or an instant message.

13. The non-transitory computer-readable storage medium of claim 9, wherein prior to uploading the content item, the method further comprises:
requesting permission to upload the content item to the online content management system;
upon receiving a response granting permission to upload the content item, proceeding to upload the content item; and
if no response granting permission to upload the content item is received, informing the user that the content item cannot be sent.

14. The non-transitory computer-readable storage medium of claim 9, wherein uploading the content item to the online content management system includes calling functionality in a code module to perform the uploading, wherein the code module is provided by an entity that operates the online content management system.

15. A non-transitory computer-readable storage medium storing instructions that when executed by a computer cause the computer to perform a method for enabling a user to send a content item through an online content management system, the method comprising:
receiving a call to upload the content item at the online content management system, the call having been generated by a client upon receiving a request to send a message which includes the content item to one or more recipients; and
in response to the call,
uploading the content item to the online content management system, and
returning a link to the uploaded content item to the client so the client can send the message including the link to the one or more recipients.

16. The non-transitory computer-readable storage medium of claim 15, wherein the message comprises one of, an email message, a text message and an instant message.

17. A system that enables a user to send a content item through an online content management system, comprising:
a computing device comprising at least one processor and a memory; and
a client on the computing device, wherein the client is configured to,
receive a command to send a message which includes the content item to one or more recipients; and
in response to the command, send the content item through the online content management system to the one or more recipients by,
uploading the content item to the online content management system,
receiving a link to the uploaded content item from the online content management system, and
sending the message including the link to the one or more recipients.

18. The system of claim 17, wherein the command specifies that the content item is to be sent through the online content management system.

19. The system of claim 17, wherein in response to the command, the content item is sent to the one or more recipients through the online content management system if a size of the content item exceeds a threshold, and otherwise the content item is sent directly with the message to the one or more recipients.

20. The system of claim 17, wherein the message comprises one of, an email message, a text message and an instant message.

21. A system that enables a user to send a content item through an online content management system, comprising:
a host for the online content management system, wherein the host comprises at least one processor and a memory; and
the online content management system which resides on the host and is configured to,
receive a call to upload the content item at the online content management system, the call having been generated by a client upon receiving a request to send a message which includes the content item to one or more recipients; and
in response to the call,
upload the content item to the online content management system, and
return a link to the uploaded content item to the client so the client can send the message including the link to the one or more recipients.

22. The system of claim 21, wherein the message comprises one of, an email message, a text message and an instant message.

23. The system of claim 21, wherein the content item comprises one or more content items.

24. A method for enabling a user to send an email message attachment through an online content management system, comprising:
receiving a command from the user to send an email message with an attachment to one or more email recipients; and
if a size of the attachment exceeds a limit, uploading the attachment to the online content management system,
inserting a link to the uploaded attachment into the email message, and
sending the email message including the link to the one or more email recipients.

25. The method of claim 24, wherein the command specifies that the content item is to be sent through the online content management system.
